(19) United States
(12) Patent Application Publication
(10) Pub. No.: US 2006/0168857 A1
(43) Pub. Date: Aug. 3, 2006

(54) Display device

(76) Inventor: Jay S. Kim, Santa Fe Springs, CA (US)

Correspondence Address: Chris Papageorge, 14625 S. Vermont #5, Gardena, CA, 90247, US

(21) Appl. No.: 11/028,697

(22) Filed: Jan. 5, 2005

(51) Int. Cl. G09F 15/00

(52) U.S. Cl. 40/606.01

(57) ABSTRACT

An advertising and promotional display device has a display sheet formed into a closed loop which is wound around a pair of rollers. A motor is connected to an upper one of said pair of rollers to rotate the roller and revolve the sheet around the pair of rollers in order to show a continuously moving set of images imprinted on the sheet. A pair of stands supports the motor as well as the upper roller so that the pair of rollers and the sheet are essentially suspended from the top ends of the stands. The rollers are composed of detachably interconnected roller members and the stands are also composed of detachably interconnected stand members enabling the device to be collapsed down into component parts for portability. A shroud covers the upper roller, the top ends of the stands and part-of the sheet. The shroud is composed of detachably interconnected segments enabling it to be collapsed into component parts for portability.

### FIELD OF THE INVENTION

The invention relates generally to displays for advertising or promotional purposes. The invention relates more specifically to devices having a display sheet formed into a continuous loop which is situated so that only a portion thereof is presented for viewing and which is in revolving motion so that the succession of visual material being displayed is regularly or selectively repeated.

### BACKGROUND OF THE INVENTION

Various types of display devices have been designed for the purpose of presenting text, graphics as well as other types of images to others. Since they can present information to many persons without requiring many personnel attending the display device, they are deemed by many teachers and persons who conduct workshops and seminars conductors to be very cost efficient. For advertising and marketing experts who use them, they are for similar reasons deemed very cost efficient and cost effective as they can convey the desired messages to many other people with minimal labor required for the presentation of the communications.

Some types of visual displays in general use are frequently made in the form of a sheet wound around a roll. Such devices have the advantage of containing a lot of text and/or images while also being compact when the sheet is rolled up. Consequently, roll display devices having the advantage of being able to display selected portions of a map, blueprint etc. are quite popular. But, since these display devices need someone to operate the device and thereby selectively display desired portions of the sheet, they are typically used by a speaker who is making an oral presentation while using the device to provide visual aids. Such devices are therefore usually used as an adjunct to oral communications. Since a device operator is typically required and the images of the device must be selectively presented by an operator, these display devices are not deemed suitable for general advertising but rather for classroom use and business meeting presentations and the like.

Many types of signs and displays are used at trade shows to advertise and promote the goods and services of those who have booths there. Many of these displays are simple signs and posters. The most sought after features of such trade show displays are that they provide high visibility and attract attention to themselves and to the site of the display. For this reason many of the displays are ornately decorated while others are composed of brilliant hues to appeal to the viewers and thereby more effectively capture their attention. Other displays are both colorful and illuminated to not only enhance visibility but also to more effectively capture the attention of those in attendance at the trade shows.

Many trade shows have a large number of booths so that the booths are crowded into a small area of the show. The businesses promoting their goods and services in such crowded spaces are thus in avid competition with each other for the attention of the trade show attendees. Consequently, many of their displays are purposely made large and situated high above those in attendance so as to enhance their visibility to a higher proportion of the attendees. But, these displays need to have sufficient structural strength to support relatively large advertising display members and to support tall posts and related structures needed to prop the viewable display members above the crowd in attendance. In order to support such large displays high above the attendees, many displays need to be relatively large and complex unitary structures to provide the structural strength needed. Such large displays are not only cumbersome, but they are also often heavy requiring a lot of labor to set up and transport. Also, those displays which are illuminated and are ornately decorated may have delicate components which require a lot of care in set up and transport to avoid damage thereto, and this adds to the labor costs involved but also necessitates excessive time required for set up and preparation for transportation. For trade show participants who desire to present their goods and services at a large number of trade shows these displays can place an undue burden on those who seek to use them. In addition, because such displays are typically unitary they take up a lot of space requiring larger transport vehicles and are characteristically likely to get in the way of trade show personnel who are busy at other tasks. Thus, such displays are disadvantageous in practice, but due to the very important need to provide effective advertisement which they do well they are used extensively nevertheless. Consequently, despite their many shortcomings, such displays are in widespread use.

Due to their many shortcomings regarding setup and transportation, many display designers have sought ways to provide the same desirable features of large displays albeit in a smaller unit. Consequently, some of the more modern display designs have included retractable components in order to facilitate setup and provide a more compact unit. An example of such a prior art display unit is disclosed in U.S. Pat. No. 6,257,418 to Allen. In the Allen invention, a cord is wound around a member and is thus in a retracted state. But, when needed the cord is unwound from that structure and stretched to the desired length. The T-shaped member of the device to which the cord attaches enables it to be positioned anywhere needed to facilitate setup in a large or small area.

Many other displays used at trade shows are designed to be a compromise between high visibility and ease of use. Some of these prior art displays have short and thin posts and their other support structures are also lightweight to enable them to be generally adapted to be mounted on a table. Such displays thus provide adequate height to provide good visibility of the advertising material. However, the tables at trade shows are also needed to display brochures and to facilitate discourse between the exhibitors and the attendees, but the displays mounted on the tables detract from that. In addition, the tables are typically narrow and short, and the fold-up type of tables commonly used are not very sturdy. The tables are therefore not capable of supporting very heavy displays. These characteristics of trade show tables limit their ability to support anything other than small displays. Therefore, due to their small size, these displays are disadvantageously limited in their effectiveness as advertising media.

It is commonly acknowledged that moving images attract more attention than stationary images. Furthermore, some believe that moving images hold a viewers attention and interest more than stationary images. Thus, these moving images are found to be generally more effective in advertising, and consequently, many people have decided to utilize some form of video display to enhance the effectiveness of their advertising campaign. However, such displays are prohibitively expensive for many persons and for some uses.

Some prior art display devices include display members that rotate in order to provide moving images and thereby more effectively attract the attention of the public. An example of such a display is disclosed in U.S. Pat. No. 6,335,714 to Wang. The Wang invention includes a display panel that is mounted on a pedestal. The display panel includes light emitting arrays and the display panel rotates on the pedestal. The light emitting arrays are colored and, in conjunction with the rotational movement provide a display that attracts and holds the viewer's attention. However, this device is complex and thus relatively expensive to manufacture. In addition, such a display is not collapsible and thus is not portable. Thus, this type of invention disadvantageously cannot be easily moved to various desired locations and are therefore permanently situated at a single location.

None of these prior art display devices provide convenience in conjunction with a very effective visual display. What is therefore needed is a display device that can be made large in order to be an effective advertising and promotion medium. What is therefore also needed is a display device that can be made high enough to be situated above the attendees at a show in order to provide enhanced visibility and thereby be a more effective advertising and promotion medium. What is also needed is such a large and tall display device that has collapsible components so that it can be made compact to provide portability to facilitate transportation to and from various trade shows. What is also needed is a display device that provides a moving display member for continuously displaying a series of visual advertising or promotional matter to more effectively attract the attention of the public.

### SUMMARY OF THE INVENTION

It is a principal object of the present invention to provide a display device which has a large display member in order to provide a high degree of visibility thereto for enhanced effectiveness in presenting various types of visual communications to the public.

It is also an object of the present invention to provide a display device which has collapsible components to provide enhanced compactness for reduced bulk and weight for ease of storage and transportation.

It is also an object of the present invention to provide a display device which has telescoping members in order to provide a large display while also enabling the device to be collapsed into a compact device for ease of transportation.

It is also an object of the present invention to provide a display device which has detachably interconnected members to provide a device which may be collapsed into a compact form for ease of transportation.

It is also an object of the present invention to provide a display device which has extendable members which are detachably interconnected to other members to facilitate setup of the device.

It is also an object of the present invention to provide a display device which conceals the mechanical components thereof to obviate the visual distraction thereof when the device is used to make a presentation to the public.

It is also an object of the invention to provide a display device having a continuous, looped display sheet having images on an entire surface thereof.

It is also an object of the invention to provide a display device having a continuous, looped display sheet having images thereon with only a portion thereof viewable to the public at any particular time to enable the selective presentation of these images.

It is also an object of the present invention to provide a display device having a continuous display sheet and associated members which are motorized to enable continuously repeated or selective presentation of images on the sheet.

It is yet another object of the present invention to provide a display device which is structurally simple for reduced manufacturing costs.

It is still another object to the present invention to provide a display device which has a straight and wide bottom surface enabling it to be stable when placed on a trade show floor surface or any other type of flat surface so that it may be placed in any desired location for enhancing its ability to be used in various types of buildings as well as outdoor environments.

Essentially, the display device of the present invention is specifically designed for presenting a large, and therefore highly visible, image to the public. The images may, for example, include graphics and pictures as well as text which are imprinted on a sheet. The device incorporates motorized members to revolve the sheet and thereby present moving images in order to more effectively attract and hold the attention of the public.

The display device of the invention is also specifically designed to be compact when not in use so that it may be easily transported and stored. This compactness feature is provided by the incorporation of telescoping support members which extend to their full length for assembly and set up of the device or collapse to their shortest length for disassembly and transport of the device to another site, as desired by the user. This compactness feature is also provided by the incorporation of detachably interconnected roller members for revolving the sheet and spacing apart portions of the sheet. These unique components thus enable sufficient extension so that they can properly support and hold a large display sheet. These components also enable them to be collapsed reducing the entire device into a more compact form for ease of transportation thereof.

The display device additionally incorporates a shroud which provides concealment of these components which provide the movement of the display sheet. The shroud also provides decorativeness to the entire combination of display sheet, rollers and motor together with the stands when the device is in use moving the sheet. In this way, it provides the dual benefit of concealing what is commonly considered not attractive while also adding a decorative feature to the device. The shroud is composed of materials which may be produced in any desired color to match the color scheme of the display images or of the room in which it is placed thereby further enhancing its decorative appeal.

A primary shortcoming of conventional shrouds used in other types of devices presenting images is that they cover up too much of the display area thereby detracting from the utility of the device by enabling less of the display available for image presentation. In contrast, however, the shroud of the present invention is a relatively small structure covering only the upper part of the device because this is the area of the motor, the tops of the stands and the upper roller. Since the lower roller is close to the floor and oftentimes blocked by the table or other such trade show structure, it is not deemed to present a distraction. By covering only these component portions it not only minimizes bulk and weight but also exposes more of the display sheet. In addition, the stand has straight lines and is therefore not generally considered unattractive or distracting and there is thus no benefit to be derived from covering it up. Moreover, covering up other component portions such as the stand body renders the sheet relatively inaccessible and thereby makes it more difficult for the user to utilize a pointer, for example, to assist the presentation.

The shroud is also collapsible as are other components of the device. The shroud is thus sectional and designed so that the components members are interconnected end to end. The shroud is open at a side thereof so that the component members can be placed within each other providing a compact shroud when not in use.

In practice, the user sets up the device by connecting the roller members together. The looped sheet is mounted around the rollers so that they space apart the sheet so that only a portion thereof is facing outward and thereby visible to the public. The stand members are also connected together to provide two stands which support the upper roller. The sheet is thus suspended from the upper roller, and both are supported by the stands. A motor at the upper end of a stand is attached to the roller for revolving the roller and sheet. The shroud members are connected together and mounted on the stands so as to cover the upper roller, upper stand portions and upper sheet portions in contact with the upper roller. Assembly of the device is thus relatively quick and simple enabling operation of the device in a relatively short period of time after delivery to the show site. Disassembly of the device after use is similarly quick and simple enabling the device to be packed away into a relatively small container. The resulting ease of transportation additionally provides the important advantage that special care is not necessary to prevent damage to that and other structures in the transport vehicle. Since the device can be packed away in a container it may be easily transported with minimal labor required and in a relatively short period of time to wherever needed.

### BRIEF DESCRIPTION OF THE DRAWINGS

FIG. 1 is a front isometric view of a first embodiment of the invention.

FIG. 2 is a front isometric view of the first embodiment showing the shroud component separated from the roller and stand components and showing the display member partly cut away illustrating the placement of the roller components thereof.

FIG. 3 is an exploded view of components of the first embodiment showing the interconnection of the stand, roller and motor components.

FIG. 4A is a right, side isometric view of the first embodiment with the shroud separated from the roller and stand components.

FIG. 4B is a right, side isometric view of the first embodiment with the shroud mounted on the roller and stand components.

FIG. 5A is a left, side isometric view of the first embodiment with the shroud separated from the roller and stand components.

FIG. 5B is a left, side isometric view of the first embodiment with the shroud mounted on the roller and stand components.

FIG. 6A is a side isometric view of the upper roller and upper end of the left stand of the first embodiment showing the shafts and recesses that enable interconnection of these components.

FIG. 6B is a side isometric view of the lower roller of the first embodiment showing the shaft and recess that enable interconnection of these components.

FIG. 7 is a front isometric view of a second embodiment of the invention.

FIG. 8 is a front isometric view of the second embodiment showing the shroud component separated from the roller and stand components and showing the display member partly cut away illustrating the placement of the roller components thereof.

FIG. 9 is an exploded view of components of the second embodiment showing the interconnection of the stand, roller and motor components.

FIG. 10A is a right, side isometric view of the second embodiment with the shroud separated from the roller and stand components.

FIG. 10B is a right, side isometric view of the second embodiment with the shroud mounted on the roller and stand components.

FIG. 11A is a left, side isometric view of the second embodiment with the shroud separated from the roller and stand components.

FIG. 11B is a left, side isometric view of the second embodiment with the shroud mounted on the roller and stand components.

FIG. 12A is a side isometric view of the upper roller and upper end of the left stand of the second embodiment showing the shafts and recesses that enable interconnection of these components.

FIG. 12B is a side isometric view of the lower roller of the second embodiment showing the shaft and recess that enable interconnection of these components.

### DETAILED DESCRIPTION OF THE PREFERRED EMBODIMENTS

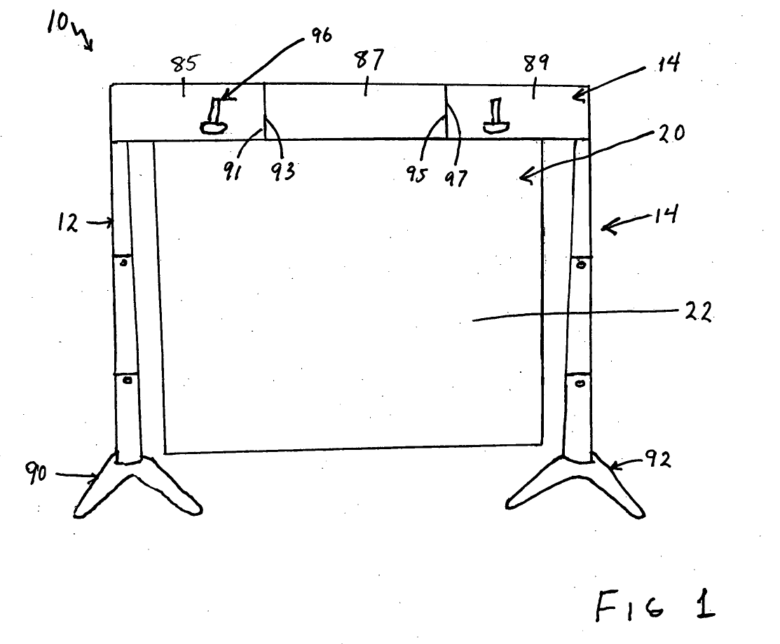

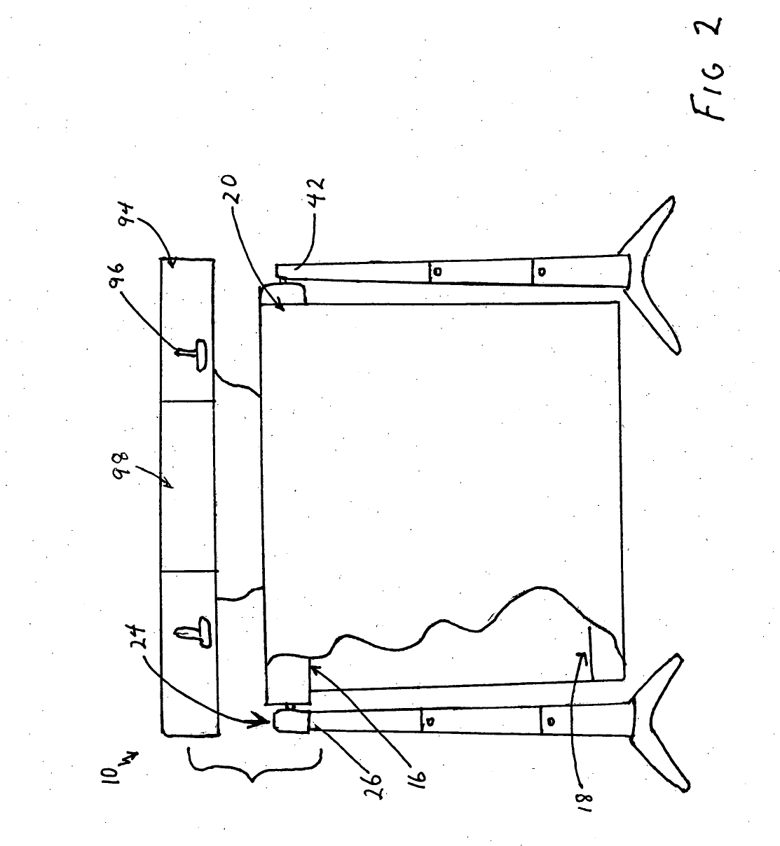

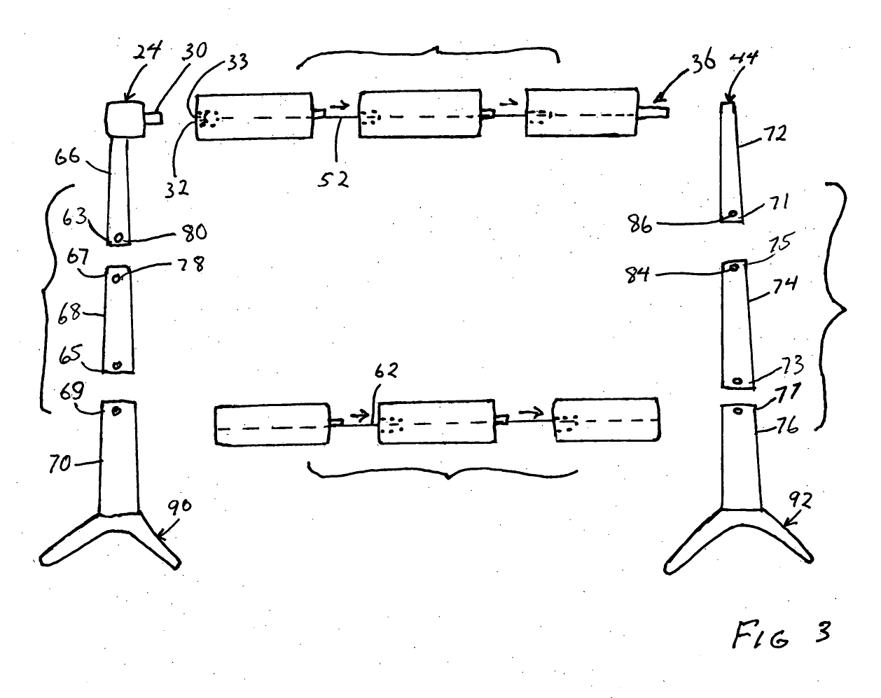

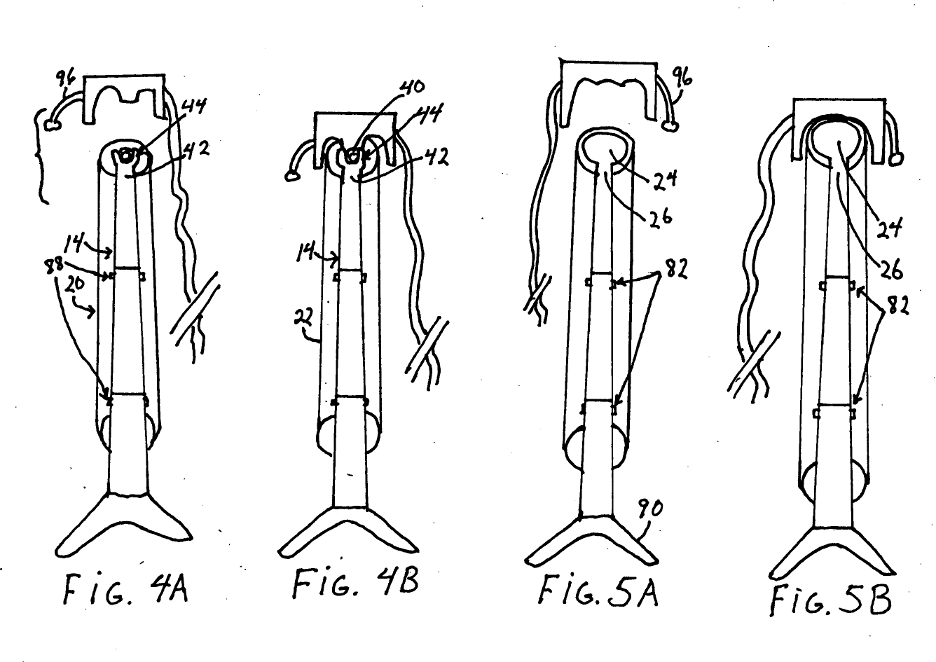

Referring to the drawings, FIGS. 1 and 2 show a first embodiment of the display device of the invention generally designated by the numeral 10. The display device 10 includes a pair of stands 12 and 14 which serve as support members. The device 10 also includes a pair of rollers 16 and 18 around which is mounted a display sheet 20.

The display sheet preferably has an image imprinted on an outer surface 22 thereof. The image may include graphics, pictures or printed words and the like. The sheet 20 is flexible and may be composed of paper, plastic or any suitable material or texture to accept text or to provide brilliantly hued images, if desired. The sheet 20 is preferably a continuous sheet formed into a closed loop of suitable diameter (or circumference) to contain the desired quantity of images thereon.

A motor 24 is preferably mounted on the upper or top end 26 of the left stand 16. The motor is operably connected the roller 16 at a left end 28 thereof. The motor is preferably electric and has an output shaft 30 which fits into a correspondingly shaped and dimensioned recess 32 in the left end 28 of the roller. The shaft 30 and recess 32 are preferably half-moon shaped (or semi-circular having a straight side) so that the shaft can operably engage the roller to revolve it. The recess 32 is defined by walls 33 with a flat wall portion 35 for engaging a corresponding flat side of the shaft 30. The upper roller 16 is preferably vertically positioned above the lower roller 18, and the lower roller is of sufficient weight that it exerts a sufficient force on the sheet 20 to result in sufficient tension on the sheet 20 that rotation of the upper roller produces revolving movement of the sheet 20. The net effect is that the images move in a vertical direction upon rotation of the motor 24 and roller 16. The resulting continuously moving images serve to attract the attention of the public at the trade shows or other display site. In addition, the motor may include a user operable switch 34 to enable selective stopping and starting of the sheet and thereby of the images. The vertical spacing of the rollers and the diametrical dimensions of the sheet determine the vertical size of the sheet portion which is visible to the viewer at any particular time. The viewable portion of the sheet 20 is preferably rectangular although it may be square, if deemed more suitable for the particular application.

The roller 16 has an axle 36 at the right end 38 thereof. The axle fits within a bushing 40 mounted at the top end 42 of the right stand 14. A forked member 44 is preferably mounted at the top end 42 and the bushing is mounted in the forked member 44. As a result of the connection of the motor 24 and output shaft 30 thereof to the roller 16 at the left end 28 and the axle connection of the roller 16 at the right end 38, the roller 16 is essentially suspended from the top ends 26 and 42 of the stands 12 and 14. The sheet 20 is also thereby suspended from the upper roller 16.

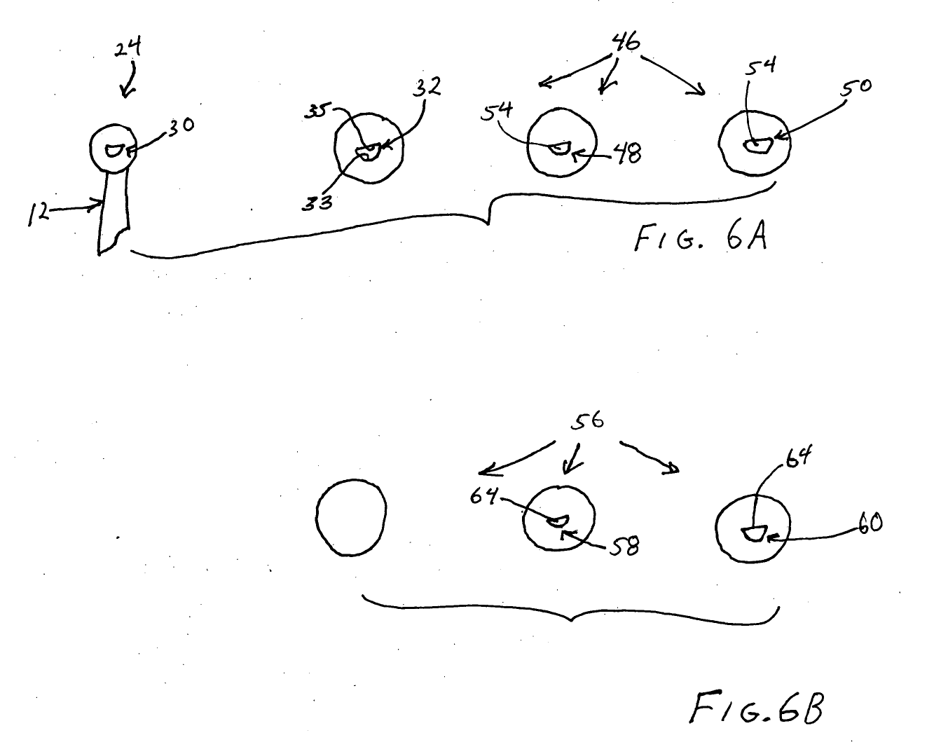

The roller 16 is preferably composed of detachably interconnected upper roller members 46. The roller members 46 are preferably hollow and cylindrical and preferably interconnected by means of upper connection shafts 48 which fit within correspondingly dimensioned upper connection recesses 50. The shafts 48 and recesses 50 are half moon shaped in cross-section (or semi-circular with a straight side), as shown in FIG. 6A. This half moon shape of the shafts 48 and recesses 50 as well as output shaft 30 and recess 32 enables the motor to drive the roller 16 by preventing undesired relative rotational movement between the roller members 46 as well as between the output shaft 30 and roller 16. The roller 16 component members 46 enable the roller to be collapsed (or broken down) into separate members which result in a dimensionally shorter roller 16 when desired. The members 46 are also preferably interconnected by an elastic cord 52 which extend through the central apertures 54 of the members 46 so that the cord 52 is axially positioned within the members 46. Although the roller 16 may be collapsed by simply pulling the members 46 apart, the elastic cord prevents the members from being completely separate thereby precluding them from getting lost and facilitating their reconnection to each other.

The roller 18 is similarly composed of detachably interconnected lower roller members 56 which are preferably hollow and cylindrical. The roller members 56 are preferably interconnected by means of lower connection shafts 58 which fit within correspondingly dimensioned lower connection recesses 60. The shafts 58 and recesses 60 are half moon shaped in cross-section (or semi-circular with a straight side), as shown in FIG. 6B. This half moon shape of the shafts 58 and recesses 60 prevent undesired relative rotational movement between the roller members 56 and enable tension of the sheet 20 to rotate roller 18 in unison with upper roller 16 thereby providing a smoother revolving movement of the sheet 20 without slippage in response to rotation of the output shaft 30. The roller's 18 component members 56 enable the roller to be collapsed (or broken down) into separate members which result in a dimensionally shorter roller 18 when desired. The members 56 are also preferably interconnected by an elastic cord 62 which extend through the central apertures 64 of the members 56 so that the cord 62 is axially positioned within the members 56. As with roller 16, the cord 62 prevents an unnecessary degree of separation of the members 56 thereby preventing them from getting lost and facilitating interconnection of the members 56.

The left stand 12 is preferably composed of stand members 66, 68 and 70 and the right stand 14 is preferably composed of stand members 72, 74 and 76. The members 66, 68 and 70 are preferably hollow and preferably detachably interconnected by means of dimensioning of the lower ends 63 and 65 so that they are diametrically smaller than upper ends 67 and 69 enabling the upper ends to fit within the lower ends. The members 66, 68 and 70 are preferably tubular and more specifically preferably frusto-conical and slidably fit together. The middle member 68 is diametrically smaller than the lower member 66 and the upper member 70 is diametrically smaller than the middle member 68 so that all the members slidably fit together and the entire stand is frusto-conical in shape. There are apertures 78 in lower ends 63 and 65 which are correspondingly positioned with apertures 80 in upper ends 67 and 69 so that when the members are interconnected, apertures 78 are in alignment with apertures 80. The alignment enables the pin 82 to fit therethrough and lock the members together. The members 72, 74 and 76 are similarly interconnected by means of dimensioning of the lower ends 71 and 73 so that they are diametrically smaller than upper ends 75 and 77 enabling the upper ends to fit within the lower ends. The members 72, 74 and 76 are preferably tubular and more specifically frusto-conical and slidably fit together. The middle member 74 is diametrically smaller than the lower member 72 and the upper member 76 is diametrically smaller than the middle member 74 so that all the members slidably fit together and the entire stand is frusto-conical in shape. There are also apertures 84 in lower ends 71 and 73 which are correspondingly positioned with apertures 86 in upper ends 75 and 77 so that when the members are interconnected, apertures 84 are in alignment with apertures 86. The alignment enables pin 88 to fit therethrough and lock the members together. The stands 12 and 14 are thus essentially telescopic. The stand 12 includes a base 90 and stand 14 includes a base 92 each preferably having three legs and a flat bottom surface for mounting on a suitable flat floor surface.

A shroud 94 is mounted on the stands at the top ends 26 and 42 thereof. The shroud 94 covers the upper roller 16 as well as the motor 24 and the top ends 26 and 42 so as to conceal these component portions from public view. The shroud 94 is preferably sectional so that it comprises preferably three segments 85, 87 and 89 which interfit at the longitudinal ends 91, 93, 95 and 97 thereof, as shown in FIGS. 1 and 2. The shroud segments 85, 87 and 89 are preferably generally U-shaped in cross-section enabling them to be stacked one within another for compactness when prepared for storage or transportation to another show site.

A pair of lamps 96 is mounted on the shroud 94 at preferably the front side 98 thereof. The lamps 96 preferably extend outwardly from the shroud 94 to overhang the sheet 20 in order to provide illumination thereof.

The stands 12 and 14 are preferably composed of a suitable metal and the rollers are preferably composed of a suitable plastic. However, they may also be composed of composite materials or other suitable materials.

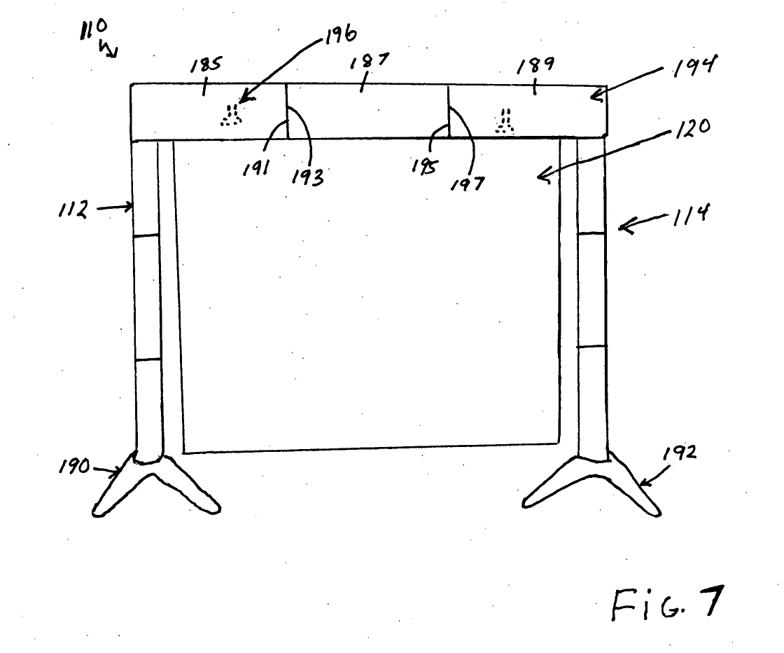

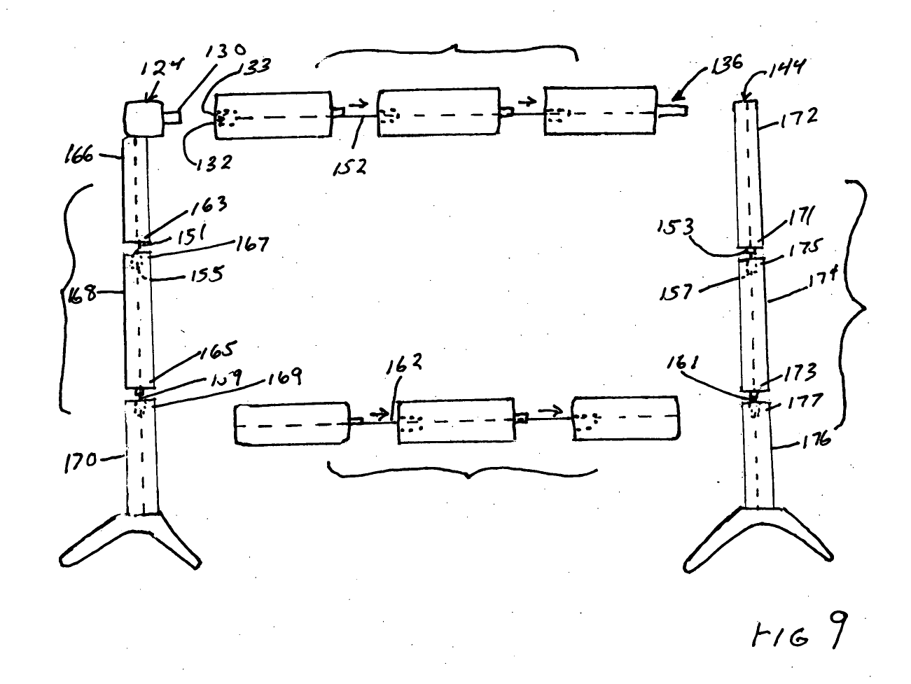

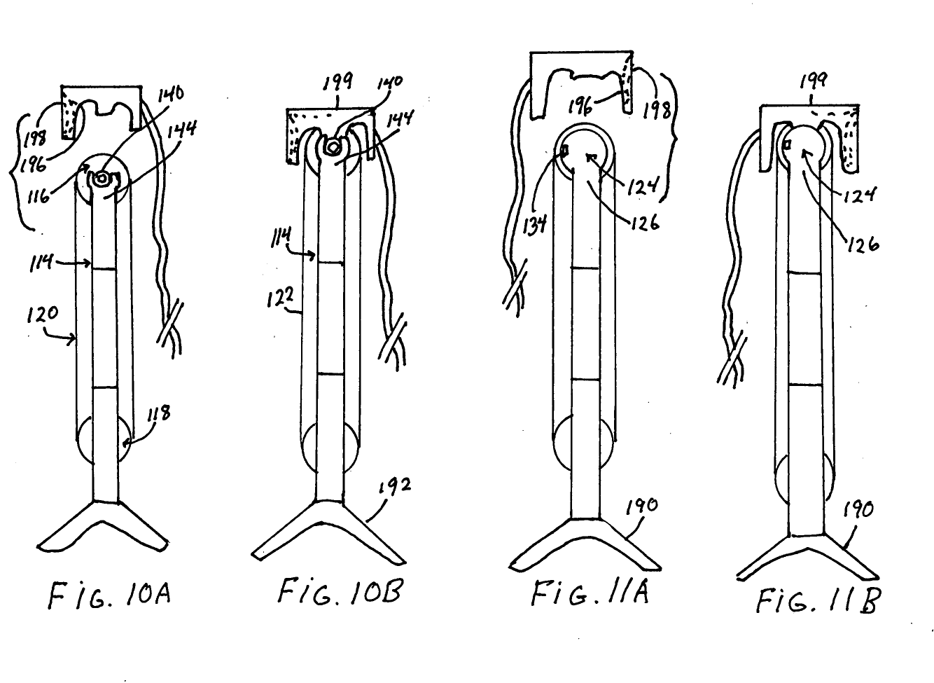

A second embodiment 110 of the invention is depicted in FIGS. 7 through 12B. The second embodiment 110 is essentially identical to the first embodiment 10 except for the stand members 166, 168, 170 and 172, 174 and 176. These members of embodiment 110 are shaped and structured differently than the comparable members of embodiment 10. More specifically, members 166, 168, 170, 172, 174 and 176 are cylindrical (and of the same diameter) rather than frusto-conical, as with the corresponding members of embodiment 10. In addition, they do not utilize the apertures and pin structures of embodiment 10. Instead, the interconnection between these members is via connection shafts 151 (at lower ends 163 and 165) and 153 (at lower ends 171 and 173) which fit within recesses 155 (at upper ends 167 and 169) and 157 (at upper ends 175 and 177) similar to the roller interconnection structures.

As with embodiment 10, embodiment 110 also includes a display sheet 120 which preferably has an image imprinted on an outer surface 122 thereof. The sheet 120 is flexible and is preferably a continuous sheet formed into a closed loop.

Embodiment 110 also includes a motor 124 which is preferably mounted on the upper or top end 126 of the left stand 116. The motor is operably connected to the roller 116 at a left end 128 thereof. The motor is preferably electric and has an output shaft 130 which fits into a correspondingly shaped and dimensioned recess 132 in the left end 128 of the roller. The shaft 130 and recess 132 are preferably half-moon shaped so that the shaft can operably engage the roller to revolve it. The recess 132 is defined by walls 133 with a flat wall portion 135 for engaging a corresponding flat side of the shaft 30. The output shaft 130 thus functions as a drive member 130 while the recess 132 functions as a driven member 132. The upper roller 116 is preferably vertically positioned above the lower roller 118. In addition, the motor may include a user operable switch 134 to enable selective stopping and starting of the sheet and thereby of the images.

The roller 116 has an axle 136 at the right end 138 thereof that fits within a bushing 140 mounted at the top end 142 of the right stand 114. A forked member 144 is preferably mounted at the top end 142 and the bushing is mounted in the forked member 144.

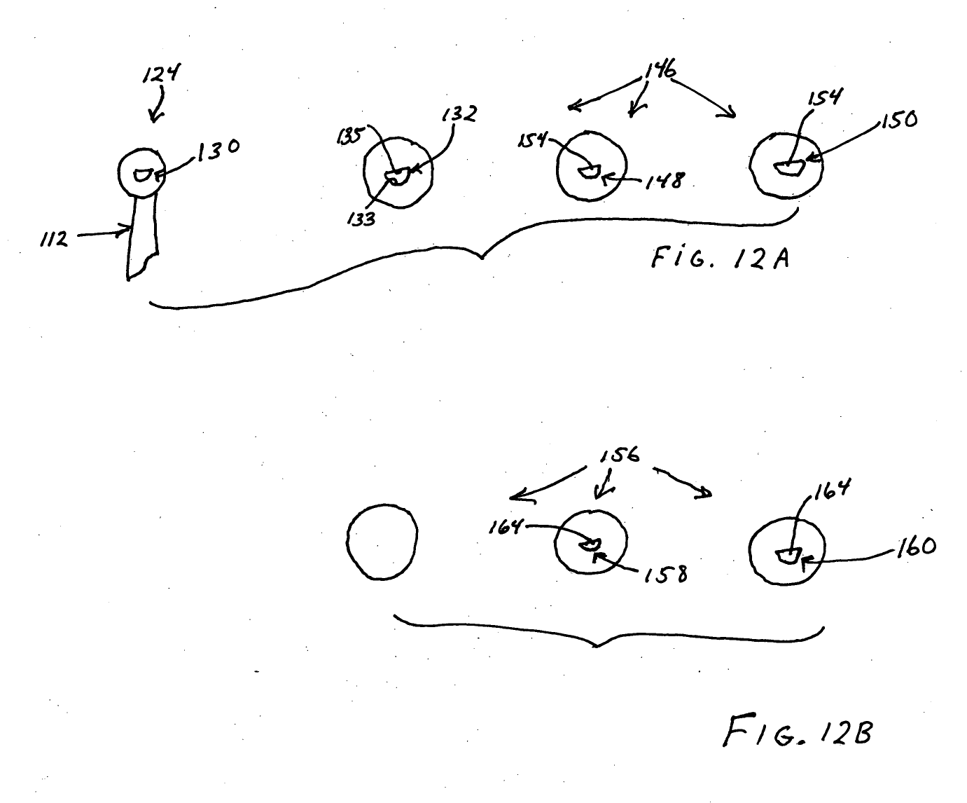

The roller 116 is preferably composed of detachably interconnected upper roller members 146 which are interconnected by means of upper connection shafts 148 which fit within correspondingly dimensioned upper connection recesses 150. The shafts 148 and recesses 150 are half moon shaped in cross-section, as shown in FIG. 12A. The members 146 are also preferably interconnected by an elastic cord 152 which extends through the central apertures 154 of the members 146 so that the cord 152 is axially positioned within the members 146.

The roller 118 is similarly composed of detachably interconnected lower roller members 156. The roller members 156 are preferably interconnected by means of lower connection shafts 158 which fit within correspondingly dimensioned lower connection recesses 160. The shafts 158 and recesses 160 are half moon shaped in cross-section, as shown in FIG. 12B. The members 156 are also preferably interconnected by an elastic cord 162 which extend through the central apertures 164 of the members 156 so that the cord 162 is axially positioned within the members 156.

The stand 112 includes a base 190 and stand 114 includes a base 192 each preferably having three legs and a flat bottom surface for mounting on a suitable flat floor surface.

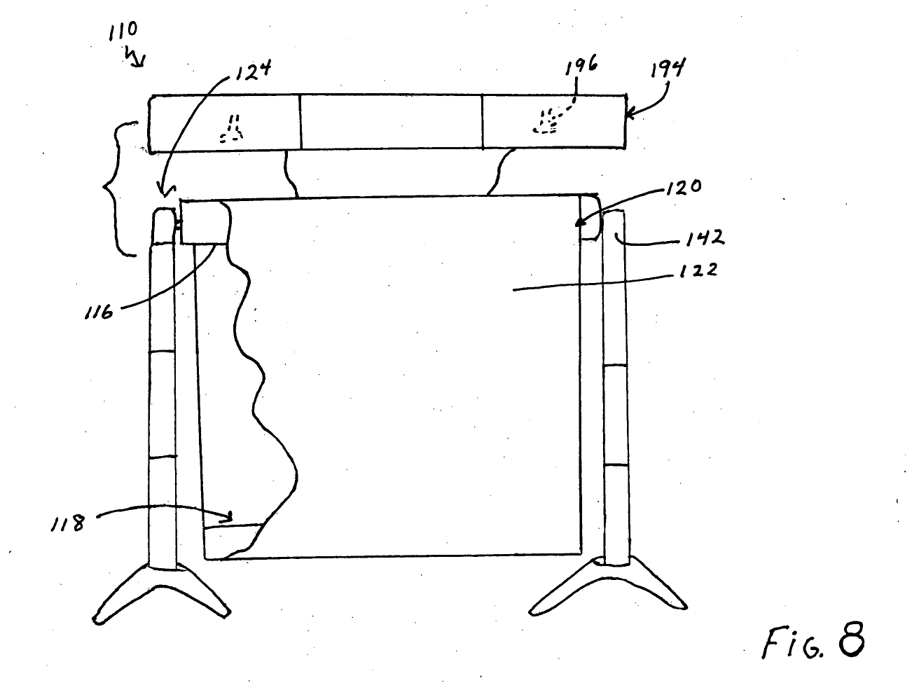

A shroud 194 is mounted on the stands at the top ends 126 and 142 thereof and partly encloses the upper roller 116 as well as the motor 124 and the top ends 126 and 142 so as to conceal these component portions from public view. The shroud 194 is preferably sectional so that it comprises preferably three segments 185, 187 and 189 which interfit at the longitudinal ends 191, 193, 195 and 197 thereof, as shown in FIGS. 7 and 8. The shroud segments 185, 187 and 189 are preferably generally U-shaped in cross-section enabling them to be stacked one within another for compactness when prepared for storage or transportation to another show site.

A pair of lamps 196 is mounted on an inner surface 199 of the shroud 194 at preferably the front side 198 thereof. The lamps 196 preferably are within the shroud and extend downwardly from the shroud 194 to overhang the sheet 120 in order to provide illumination thereof.

Accordingly, there has been provided, in accordance with the invention, an improved display device for a trade show or other suitable public or private viewing site which provides enhanced compactness and portability in conjunction with a relatively large display image. It is to be understood that all the terms used herein are descriptive rather than limiting. Although the invention has been described in conjunction with the specific embodiments set forth above, many alternative embodiments, modifications and variations will be apparent to those skilled in the art in light of the disclosure set forth herein Accordingly, it is intended to include such alternative embodiments, modifications and variations that fall within the spirit and scope of the invention set forth in the claims hereinbelow.

What is claimed is:

1. A display device, comprising:
a pair of rollers;
a motor connected to at least one of said rollers, for rotation thereof;
a stand for supporting said roller;
a forked member secured to said stand, said forked member engaging said roller for rotational movement thereof relative to said stand;
a display sheet forming a continuous loop, said display sheet mounted around said rollers to enable said motor to move said sheet around said rollers via rotational movement of said roller.

2. The display device of claim 1 wherein said pair of rollers are composed of roller members which are detachably interconnected so that said pair of rollers are collapsible.

3. The display device of claim 2 wherein said roller members include connection shafts at an end thereof and connection recesses at opposite ends thereof for detachable interconnection of said roller members, said connection shafts and said connection recesses half-moon shaped in cross-section.

4. The display device of claim 1 wherein said stand is composed of stand members which are detachably interconnected so that said stand is collapsible.

5. The display device of claim 1 wherein said stand includes a left stand and a right stand positioned at lateral ends of said pair of rollers.

6. The display device of claim 1 further including a shroud connected to said stand and positioned adjacent said roller for partly enclosing said roller.

7. The display device of claim 1 wherein said roller includes:
an axle;
a bushing mounted around said axle, said bushing rigidly connected to said stand for supporting said roller on said stand.

8. The display device of claim 1 wherein said motor includes a drive member and wherein said roller includes a driven member for engaging said output shaft to allow said motor to rotate said roller.

9. The display device of claim 8 wherein said driven member is located at an end portion of said roller.

10. The display device of claim 1 further including a lamp securely mounted on said shroud for illuminating said sheet.

11. The display device of claim 9 wherein said lamp is positioned within said shroud.

12. The display device of claim 8 wherein said driven member includes walls defining a recess, the walls having a flat wall portion to receive a correspondingly flat surface portion of the output shaft.

13. The display device of claim 12 wherein the recess is half-moon shaped.

14. The display device of claim 1 wherein said sheet has display material imprinted on an outer surface thereof to selectively display consecutive portions of said material during rotation of said roller and revolving movement of said sheet around said roller.

15. The display device of claim 14 wherein said roller includes an upper roller and a lower roller which are spaced apart a selected distance so that a viewable portion of said sheet is rectangular.

16. A display device, comprising:
a stand;
a motor securely mounted on said stand;
an upper roller connected to said motor to enable said motor to rotate said first roller;
a lower roller;
a display sheet forming a continuous closed loop, said display sheet mounted around said upper roller and said lower roller to enable said motor to revolve said sheet around said upper roller and said lower roller via rotational movement of said upper roller.

17. The display device of claim 14 wherein said lower roller has sufficient weight to produce sufficient tension on said sheet to enable said motor to revolve said sheet without slippage of said sheet on said upper roller and said lower roller.

18. The display device of claim 14 wherein said stand includes a left stand and a right stand.

19. The display device of claim 16 wherein said motor is mounted on said left stand.

20. The display device of claim 16 wherein said upper roller includes an axle and wherein said right stand includes a forked member at a top end thereof for receiving said axle at an open portion thereof for supporting said upper roller while allowing said upper roller to rotate relative to said right stand.

21. The display device of claim 19 further including a bushing mounted in said open portion for receiving said axle therein.
